(19) United States
(12) Patent Application Publication
(10) Pub. No.: US 2007/0292197 A1
(43) Pub. Date: Dec. 20, 2007

(54) INTERNAL FEED MANUAL PAINT BRUSH

(76) Inventors: Craig Peterson, Carver, MN (US); Ross Rossner, St. Michael, MN (US); Allen Arden Caldwell, Shakopee, MN (US); Robert H. Bruno, Avon, CT (US); Joseph Toro, Stratford, CT (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(21) Appl. No.: 11/425,264

(22) Filed: Jun. 20, 2006

(51) Int. Cl. B43M 11/06; A46B 11/04

(52) U.S. Cl. 401/183; 401/271

(57) ABSTRACT

A manually operated internally fed paint brush having a resilient handle forming a refillable paint reservoir and a brush head with a fluid delivery path connecting the reservoir to the brush head via a siphon tube having an inlet positioned at a lowermost region of the reservoir when the paint brush is generally horizontal. A combined valve and O-ring seals an outlet of the siphon tube and selectively opens in response to compression of the reservoir. A latching mechanism retains the brush head to the handle. A trough having a spout is provided for filling the paint brush.

### BACKGROUND OF THE INVENTION

The present invention relates to the field of internal feed paint applicators, particularly brushes. In the past, some applicators, such as those related to U.S. Pat. No. 5,904,434 and U.S. Pat. No. 5,139,357, have included two elements connected by a hose. One element was a pump and paint reservoir and the other element was a hand held paint brush, with paint delivered to the brush through the hose. Another type was a conventionally styled paint applicator head that was attachable to a bottle containing paint, such as shown in U.S. Pat. No. 6,439,381. To use such a manual delivery prior art device, the bottle was required to be tipped until the applicator was below the level of the bottle, at which time the bottle was squeezed, and gravity delivered the paint to the applicator.

Another type of prior art paint applicator is illustrated in U.S. Pat. No. 6,145,151. In this patent a non-internal feed paint brush is described as having an asymmetric brush handle.

### BRIEF SUMMARY OF THE INVENTION

In one aspect, the present invention includes a paint reservoir that does not need to be tipped to replenish or reload the brush head with paint. An internal siphon tube is positioned to draw paint from a lowermost region of the paint reservoir in the handle with the brush in a generally horizontal position, i.e., with the brush head positioned generally horizontal to the handle reservoir. While in this position, a user need merely squeeze the handle to deliver paint from the reservoir to the brush head, without repositioning the brush in the hand of the user.

A further aspect of the present invention is a vacuum breaker located in a fill cap to prevent buildup of vacuum in the reservoir as the paint is used up.

Additionally, the handle (formed by the reservoir) is preferably non-symmetric, encouraging a user to grasp the paint brush in a manner recommended by professional painters with the handle extending back between the thumb and forefinger and above a user's hand.

In another aspect, the present invention may include a system that can accommodate a plurality of brush heads of different widths, each connectable to the same handle and paint reservoir, resulting in commonality of parts and economies of scale in the manufacture of products according to the present invention.

A further aspect of the present invention may include an offset position for wider brush heads.

In still another aspect, the present invention includes a latching mechanism for securely retaining the brush head to the handle, while at the same time allowing easy removal and installation without requiring the use of tools.

A paint loading device is provided to load the handle reservoir, with the paint loading device being in the form of a gravy-boat-like trough with a spout at one end for convenience in filling the reservoir.

### BRIEF DESCRIPTION OF THE SEVERAL VIEWS OF THE DRAWINGS

FIG. 1 is a perspective view of a paint brush according to the present invention.

FIG. 2 is an edge view of the paint brush of FIG. 1.

FIG. 3 is a partially cut away side view of the paint brush of FIG. 1.

FIG. 4 is an exploded view of a paint brush head according to the present invention, but with bristles omitted to illustrate certain features of the brush head.

FIG. 5 is an exploded view of the handle portion of the paint brush of the present invention.

FIG. 6 is a section view of the handle portion of the paint brush of the present invention taken along line V-V of FIG. 2.

FIG. 7 is an enlarged section view of an adapter useful in the practice of the present invention.

FIG. 8 is an enlarged fragmentary view of a portion of FIG. 6.

FIG. 9 is an enlarged perspective view of a case half from FIG. 5.

FIG. 10 is a plan view of a combined valve and O-ring useful in the practice of the present invention.

FIG. 11 is a section view taken along line XI-XI of FIG. 10.

FIG. 12 is an enlarged view of detail XII of FIG. 11.

FIG. 13 is a perspective view of a trough useful to fill the paint brush of the present invention.

FIG. 14 is a side elevation view of the trough of FIG. 13.

FIG. 15 is a top plan view of the trough of FIG. 13.

FIG. 16 is a section view taken along line XVI-XVI of FIG. 15.

FIG. 17 is a rear elevation view of the trough of FIG. 13.

FIG. 18 is a front elevation view of the trough of FIG. 13.

### DETAILED DESCRIPTION OF THE INVENTION

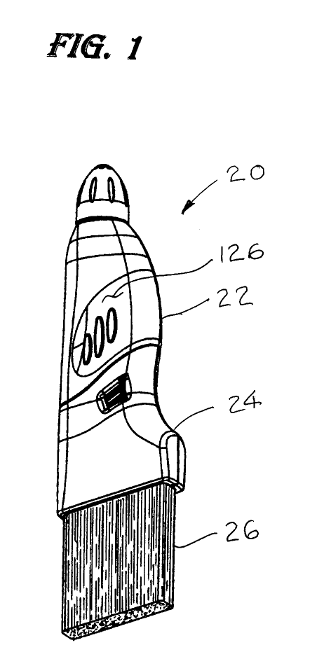

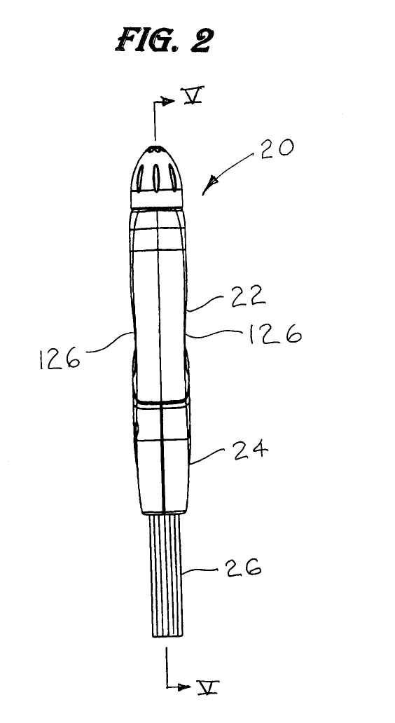

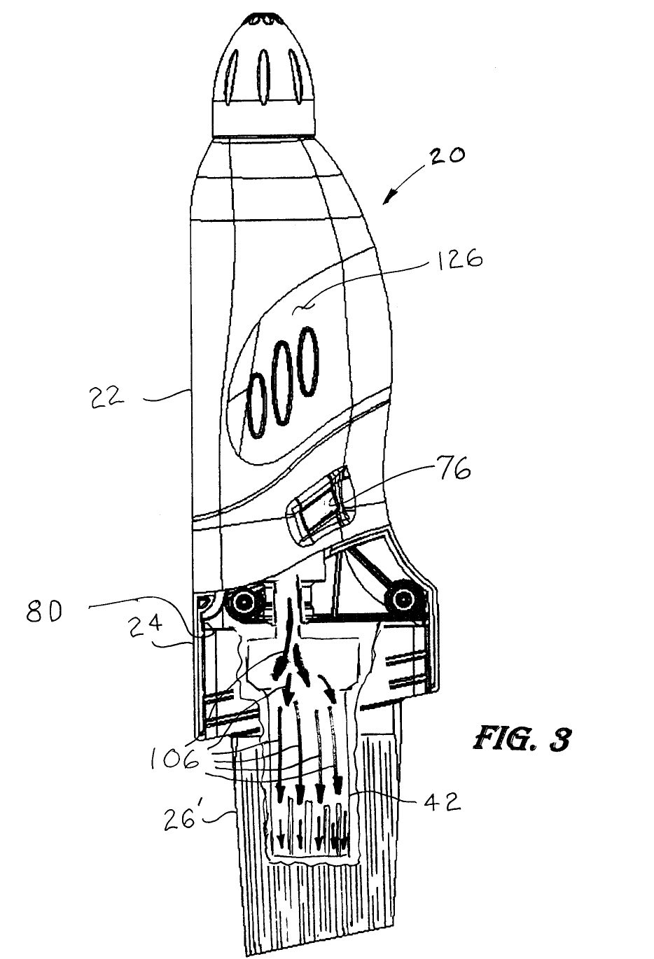

Referring now to the Figures, and most particularly to FIGS. 1-3, a paint brush 20 useful in the practice of the present invention may be seen. Brush 20 includes a handle 22 and a brush head 24. Brush head 24 has a plurality of bristles 26 which may be in the form of a straight or conventional pattern as shown in FIG. 1 or the bristles may be arranged in a tapered or sash brush configuration 26′ or pattern as shown in FIG. 3.

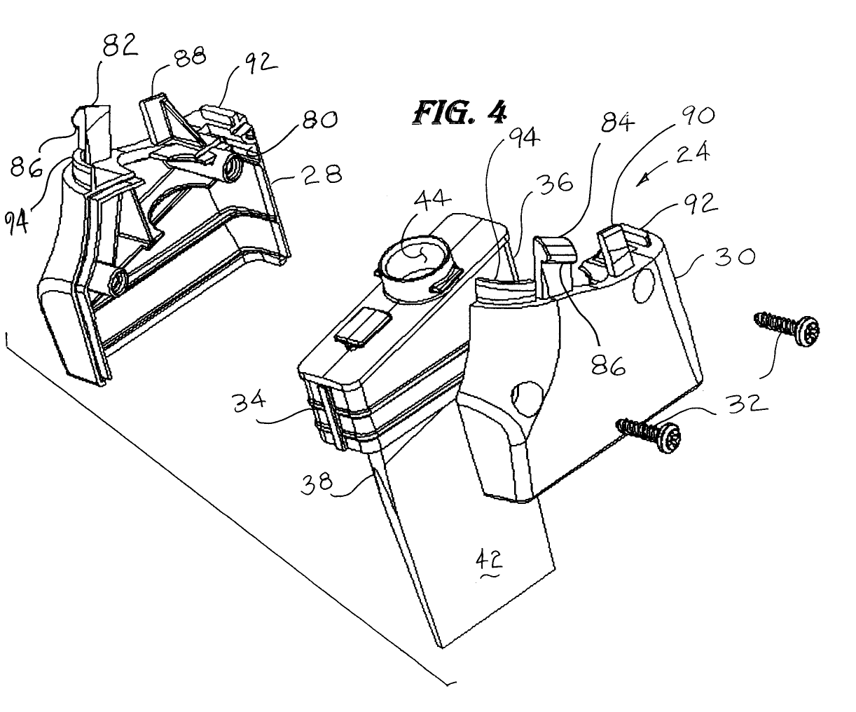

Referring now also to FIG. 4, the brush head 24 may have a left case half 28 and a right case half 30 attached together by screws 32 and surrounding a bristle head assembly 34. The bristle head assembly 34 may have a metal ferrule 36 securing the bristles or filaments of the brush head to a distributor assembly 38, which in turn may include a body 40 and distributor 42. The distributor 42 is a flat, liquid impermeable fabric of nylon or other similar woven material formed into a sleeve configuration and in fluid communication with the body 40 such that fluid delivered to an aperture 44 in the body is free to flow through the sleeve of the distributor 42 for delivery to the bristles 26. Desirable characteristic features of the distributor 42 are that it is relatively flat and highly flexible and may even be sufficiently limber to be non-self supporting, to avoid or minimize affecting the leveling action of the filaments 26 as paint is applied to a surface by the brush 20. The filaments or bristles 26 may be secured within the assembly 34 by a conventional epoxy material. The parts, materials and construction of the assembly 34 may be the same or similar to that shown and described in U.S. Pat. No. 5,904,434, Internal Feed Paintbrush, the entire contents of which are hereby expressly incorporated by reference.

As used herein the word “paint” is to be understood to refer to paint and similar architectural coating materials, including but not limited to paints (both water and mineral spirit soluble) and stains.

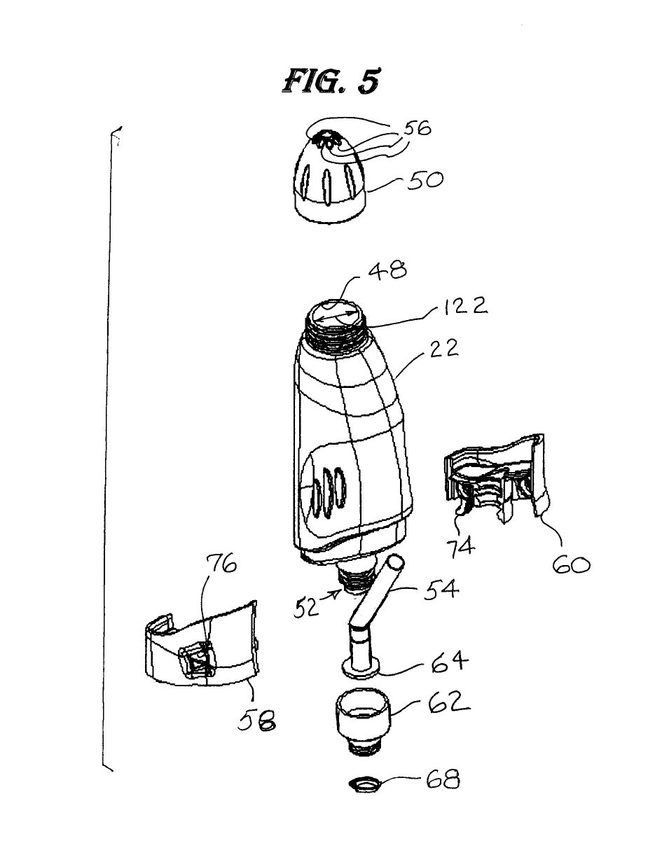

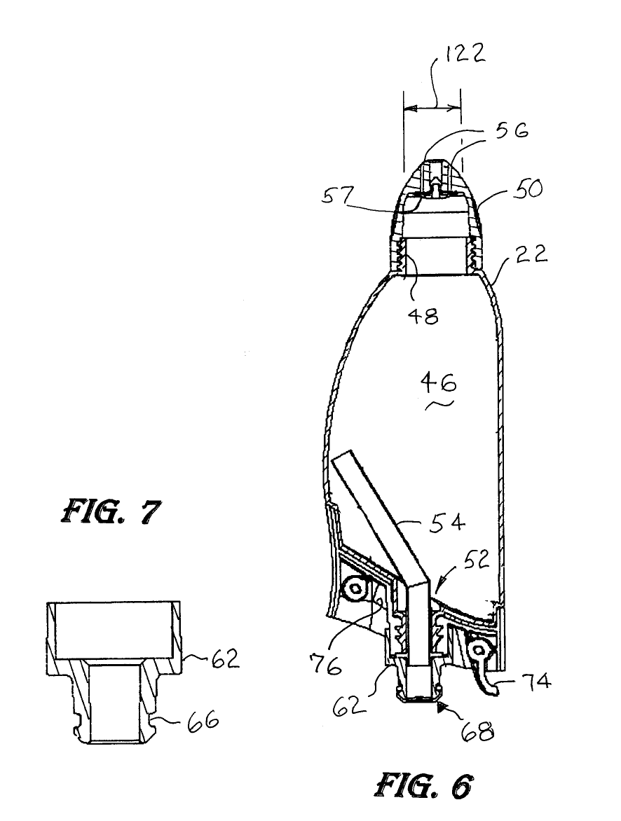

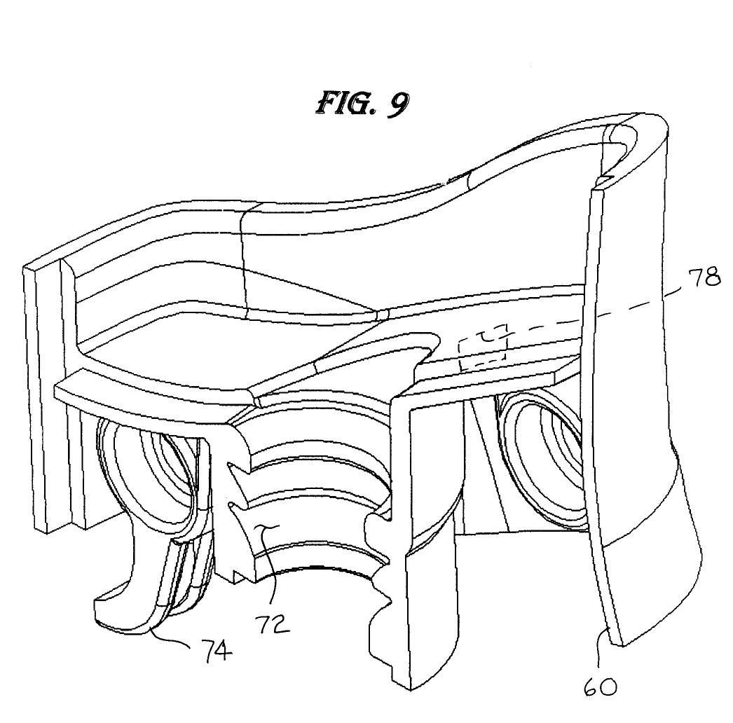

Referring now also to FIGS. 5-9, various details of the handle 22 may be seen. Handle 22 includes a paint reservoir 46 having a first opening 48 closed by a cap 50 and a second opening 52 which receives a siphon tube 54. Cap 50 has a plurality of vent apertures 56 closed by a conventional umbrella valve 57. Valve 57 is a vacuum breaker valve which opens to relieve vacuum in reservoir 46 as it is depleted of paint during operation. Cap 50 may be threadably received on the handle 22 to selectively open and close the first opening 48 of the reservoir 46, as desired. A pair of handle case halves 58 and 60 may be attached to the handle in the region surrounding the second opening 52 and the projection of the siphon tube 54 out of the reservoir 46. A pair of conventional screws (not shown) may be used to secure halves 58 and 60 together. A step down adapter 62 may be secured to a flange 64 on the siphon tube 54 and case halves 58, 60 by a conventional solvent bond. Adapter 62 may have a circumferential groove 66 to receive and retain a seal 68 in the form of a combined valve and O-ring.

The handle case halves 58 and 60 may be secured to the second opening 52 of the reservoir 46 by a plurality of rings 70 on the opening 52 and mating rings 72 on the case halves 58 and 60. It is to be understood that the reservoir 54 forming the main part of the handle 22 is formed of a relatively flexible polymer, such as polyethylene, while the handle case halves 58 and 60 may be formed of a relatively more rigid polymer. The brush head case halves 28 and 30 may also be formed of a relatively more rigid polymer. As used herein the reservoir and handle may be referred to interchangeably, however, the handle 22 may optionally be considered to also include parts other than the reservoir 46, for example, the handle case halves 58, 60, the siphon tube 54 and the step down adapter 62.

The handle case formed by case halves 58 and 60 may has a hook 74 formed integrally therewith and extending therefrom. Each of handle case halves 58, 60 also has a rectangular aperture 76, 78. Hook 74 is received in a recess 80 formed in the brush head case made up of halves 28 and 30. Ears 82 and 84 may be received, respectively by apertures 76 and 78 when the brush head 24 is attached to the handle 22. Each of ears 82, 84 has a lip 86 to retain the brush head 24 against inadvertent separation from the handle 22. When it is desired to remove the brush head 24 from the handle, ears 82 and 84 are depressed sufficiently such that lips 86 clear the interior edge of the respective apertures 76, 78, allowing the brush head 24 to be pivoted on hook 74 away from the handle 22 until the hook 74 withdraws from the recess 80, allowing full separation of the brush head 24 from the handle 22. A pair of side guide posts 88, 90 and a pair of end walls 92, 94 assist the user in guiding the brush head 24 into alignment with the handle case 58, 60 when the brush head 24 is being installed on the handle 22. Additionally, the posts 88, 90 and end walls 92, 94 maintain alignment and rigidity between the brush head 24 and the handle 22 when assembled together. The ears 82, 84 and apertures 76, 78 form a latching mechanism for releasably retaining the brush head 24 to the handle 22. The latching mechanism may optionally also include hook 74 and recess 80, and may further optionally include posts 88, 90 and end walls 92, 94 with corresponding mating surfaces in the handle case halves 58, 60.

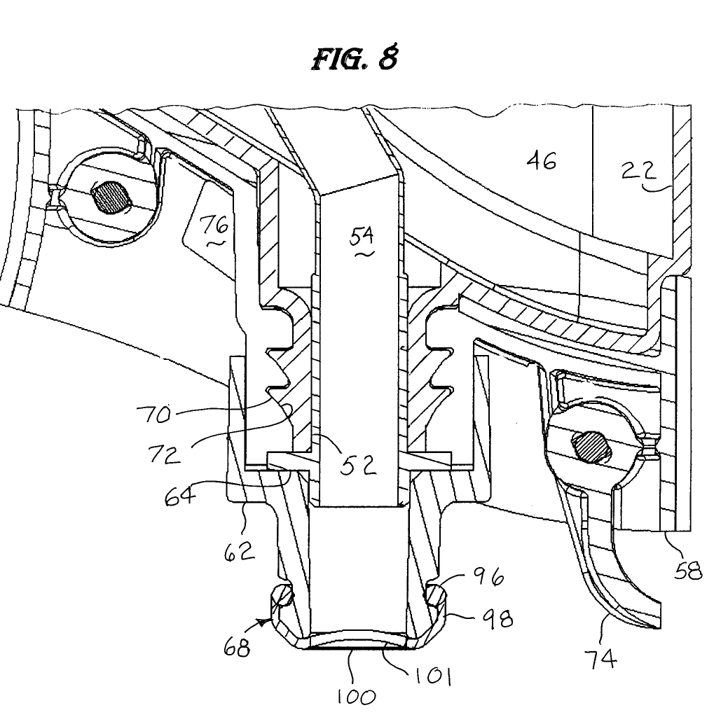

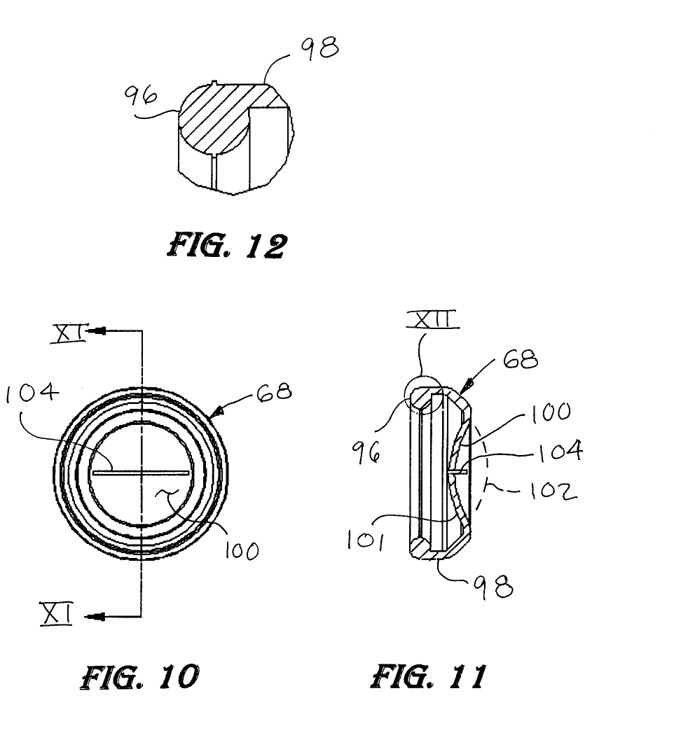

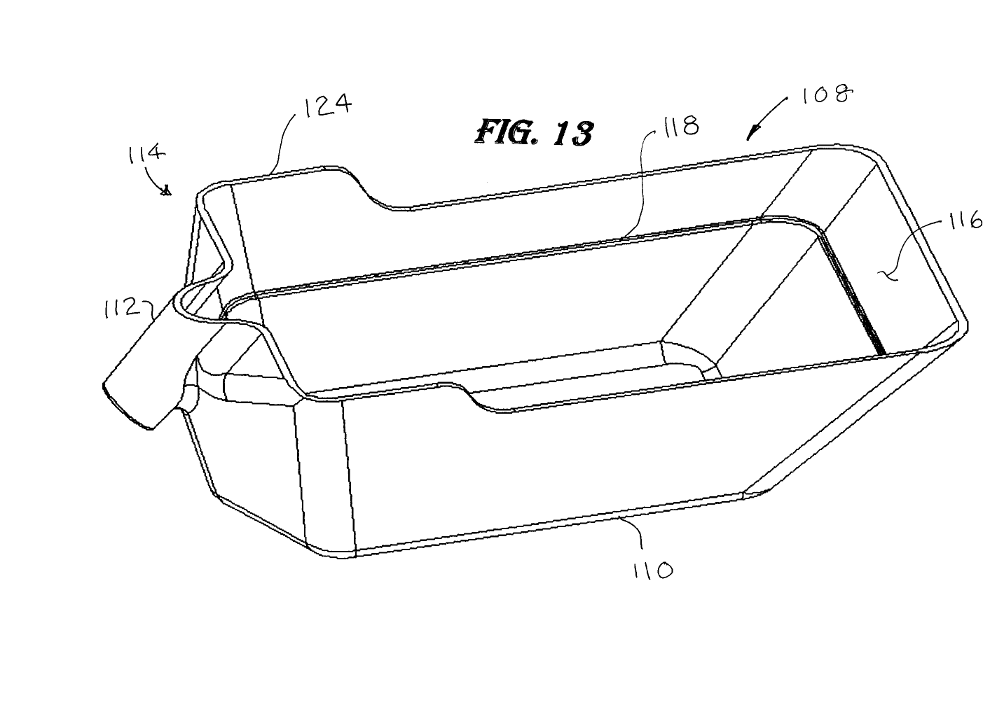

Referring now most particularly to FIGS. 8-12, details of the construction and installation of the combined valve and O-ring making up seal 68 are shown. An O-ring portion 96 is similar to a conventional O-ring, except that it is attached to a peripheral rim 98 of the seal 68 as is a valve portion 100. FIGS. 8 and 11 show the valve portion 100 in its relaxed or CLOSED state, with a dome 102 forming a convex surface facing the O-ring portion 96. It is to be understood that FIG. 8 shows a section view of the combined valve and O-ring 68 along a line that is perpendicular to line XI-XI. Dome 102 has a slit 104 that is closed when the valve is in its relaxed state. Dashed line 102 shows the position the valve portion moves to when the valve is deformed to an OPEN state, as would occur when paint in the reservoir 46 is pressurized by squeezing the handle 22. In the OPEN state, valve 100 allows paint to flow from the reservoir 46 through the valve 100 to be delivered to the bristles 26, as indicated by arrows 106 in FIG. 3. It has been found desirable to lubricate the combined valve and O-ring 68 to assist in installing the O-ring portion 96 in groove 66 to avoid post installation residual stresses in the valve portion 100 which could otherwise adversely affect the operation of valve portion 100.

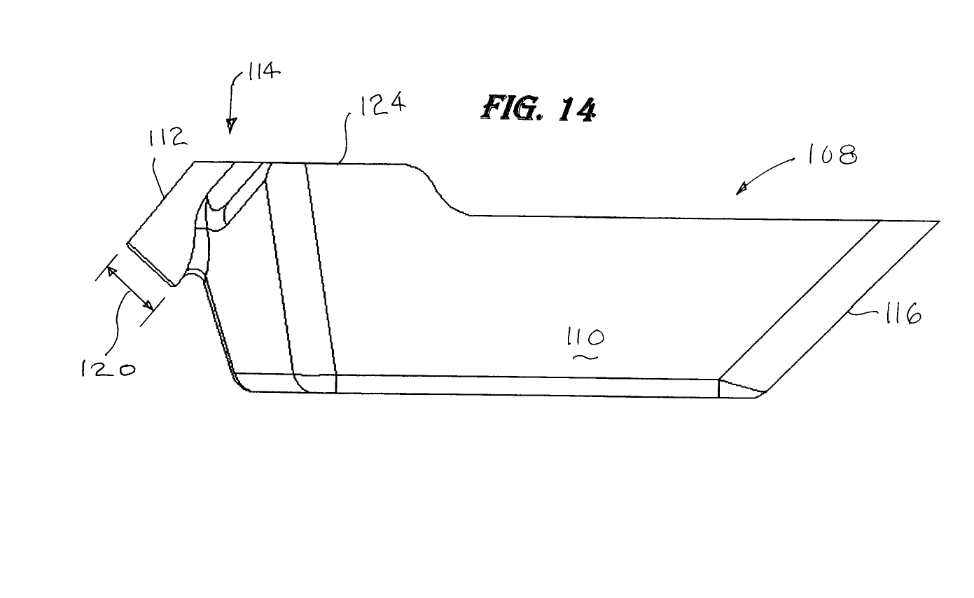

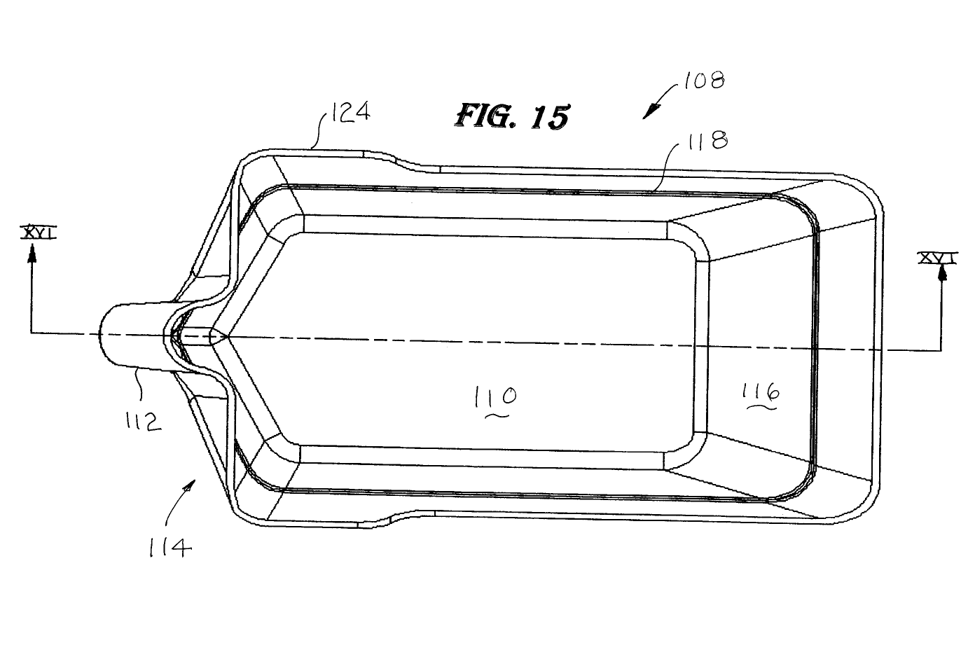

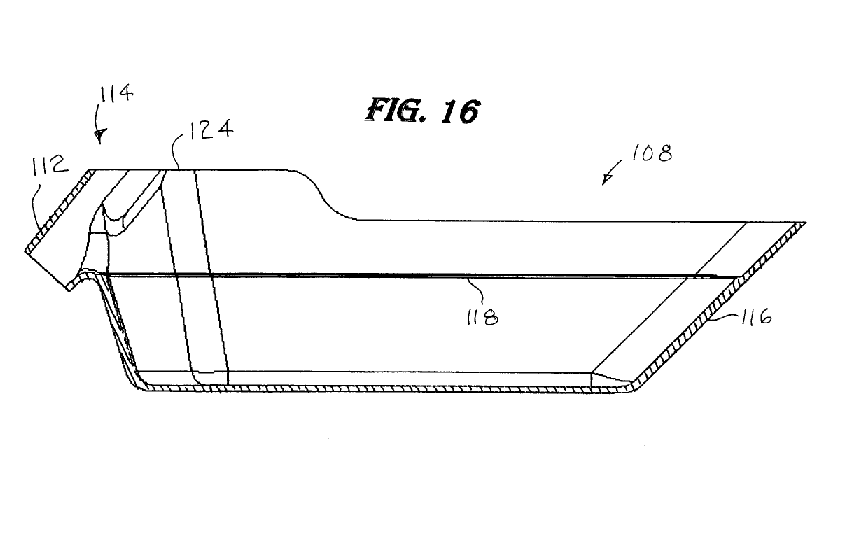

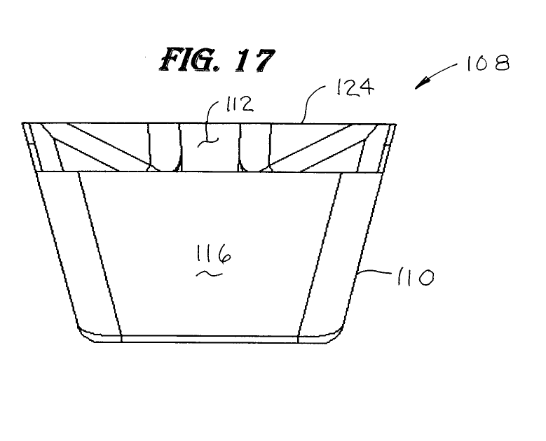

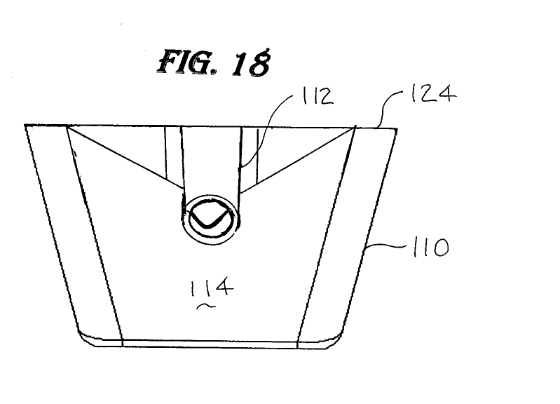

Referring now to FIGS. 13-18, various views of a paint loading device or trough 108 useful to fill the paint brush of the present invention may be seen. Trough 108 may include a generally rectangular body 110 with an integral spout 112 at a front end 114 thereof. A rear wall 116 may be sloped, to assist a user in both filling and emptying the trough 108 with respect to a conventional paint container, such as a one gallon (or other capacity) paint container in which paint is conventionally vended. Trough 108 may have a fill line 118 molded therein to assist a user in avoiding overfilling the trough 108. As shown, filling the trough 108 to the fill line 118 will provide enough paint in the trough 108 to fill the paint reservoir 46 twice. It is to be understood that an outside diameter 120 of the spout 112 is less than the inside diameter 122 of the first opening 48 of the paint reservoir 46, thus enabling a user to readily insert the spout 112 into the first opening 48 for conveniently and quickly delivering paint from the trough 108 to the paint reservoir 46 of the handle 22 without spilling. A raised wall portion 124 is provided at the front end 114 of the trough 108 to avoid spilling when the trough 108 is tipped to deliver paint to the reservoir 46.

To use the paint brush 20, a user will load the trough 108 with paint, remove the cap 50 from the first opening 48 of the paint reservoir 46 in the handle 22, and pour paint from the trough 108 into the paint reservoir 46 while the spout 112 is held within the first opening 48. Once the reservoir 46 is filled, the cap 50 is replaced. While the reservoir 46 is being filled the valve and O-ring 68 prevents paint from leaking out of the second opening 52 of the reservoir 46 via the siphon tube 54.

To load paint from the reservoir 46 to the bristles 26, the brush 20 is oriented as and if necessary to position a siphon tube inlet 126 within the paint held in the reservoir 46. As mentioned previously, the inlet 126 is positioned at a lowermost portion of the reservoir 46 when the brush 20 is held generally horizontally. The user then manually compresses or squeezes the reservoir causing paint to flow as indicated by arrows 106 in FIG. 3. It is to be understood that it is not necessary for the brush 20 to be positioned vertically (as illustrated in FIG. 3) to deliver paint to the bristles 26. The bristles 26 may be replenished with paint with the brush 20 held horizontally by the user.

In use, the paint brush 20 is intended to be grasped by a user with the handle 22 located between the user's thumb and one or more fingers on the same hand. A slightly concave depression may be formed on each side of the handle 22 to receive and position the thumb and forefinger, respectively.

When painting is completed, the brush head 24 may be separated from the handle 22 by simultaneously depressing the ears 82 and 84 until lips 86 are clear of engagement with apertures 76 on each side of the handle case halves 58, 60. The brush head 24 is then rotated about hook 74 until the brush head 24 is clear of the handle 22, at which time each may be cleaned by an appropriate solvent for the type of paint being used, e.g., water for a latex based coating, or mineral spirits for an oil based coating.

The invention is not to be taken as limited to all of the details thereof, as modifications and variations thereof may be made without departing from the spirit and scope of the invention.

1. An internally fed paint brush of the type having paint delivered to a brush head, the paint brush comprising:
a. a brush head having a plurality of filaments and an internal passageway in fluid communication with the plurality of filaments; and
b. a handle removably connected to the brush head and having a reservoir and a siphon tube connected to draw paint from a lowermost region of the reservoir when the handle is generally horizontal and deliver paint to the brush head via the siphon tube and internal passageway of the brush head.

2. The paint brush of claim 1 wherein the paint is delivered when the reservoir is compressed.

3. The paint brush of claim 1 further comprising a seal connected between the siphon tube and the internal passageway of the brush head.

4. The paint brush of claim 3 wherein the seal has a valve portion is normally closed and opens in response to compression of the reservoir.

5. The paint brush of claim 3 wherein the seal has an O-ring portion connected to the valve portion.

6. The paint brush of claim 1 further comprising a removable cap closing a fill opening of the reservoir.

7. The paint brush of claim 6 further comprising a vacuum breaker valve to prevent vacuum in the reservoir as paint is delivered from the reservoir to the brush head.

8. The paint brush of claim 1 further comprising a latching mechanism to retain and selectively release the brush head from the handle.

9. The paint brush of claim 8 wherein the latching mechanism comprises at least one ear on one of the handle and brush head and at least one mating aperture on the other of the handle and brush head wherein when the ear is received in the aperture the brush head is retained to the handle, and when the ear is displaced from the aperture, the brush head is released from the handle.

10. The paint brush of claim 1 wherein the handle has a pair of concave depressions on opposite sides of the handle sized and positioned to receive a thumb and a forefinger of a user grasping the paint brush.

11. A system for filling an internally fed paint brush of the type having paint delivered to a brush head, the system comprising:
a. a paint brush having:
i. a brush head having a plurality of filaments and an internal passageway in fluid communication with the plurality of filaments, and
ii. a handle connected to the brush head and having a reservoir and a fill opening, the reservoir in fluid communication with the fill opening and the internal passageway of the brush head; and
b. a paint loading device having:
i. a trough shaped body portion for holding paint, and
ii. a spout sized to interfit with the fill opening to delivery paint from the body portion to the reservoir.

12. The system of claim 11 wherein the paint loading device further comprises a fill line within the body portion to indicate a proper fill amount for the paint loading device.

13. The system of claim 12 wherein the paint loading device further comprises a raised wall portion at the spout end of the body portion.

14. The system of claim 11 wherein the fill opening has an inside diameter and the spout has an outside diameter less than the inside diameter of the fill opening to allow the spout to be received in the fill opening.

15. A method of delivering paint from a handle to a brush head in an internally fed manual paint brush comprising the steps of:
a. providing a deformable paint reservoir in the handle of the paint brush, with a portion of the handle located lowermost in the reservoir when the handle is oriented generally horizontally;
b. locating a siphon tube in the handle such that an inlet of the siphon tube is positioned in the lowermost port of the reservoir;
c. providing a fluid passageway from the siphon tube to the brush head; and
d. squeezing the paint reservoir to drive paint from the reservoir through the siphon tube to the paint head.

16. The method of claim 15 further comprising the additional steps of:
e. releasing the paint reservoir; and
f. breaking a vacuum in the reservoir when the paint reservoir is released.

17. The method of claim 15 wherein step c further comprises providing a normally closed valve in the fluid passageway which opens in step d.

18. The method of claim 17 wherein the valve is a pressure relief valve having a domed surface convex toward the siphon tube when in the normally closed condition.

19. The method of claim 18 wherein the domed surface of the valve moves to a concave condition facing the siphon tube when in an open condition.

20. The method of claim 15 further comprising an additional step prior to step d, of:
c1. filling the paint reservoir using a paint loading device having a spout engaged with a fill opening of the reservoir.
